(19) United States
(12) Patent Application Publication
(10) Pub. No.: US 2011/0318564 A1
(43) Pub. Date: Dec. 29, 2011

(54) AIRCRAFT INSULATING FOAM

(76) Inventors: Feng Qin, Charlotte, NC (US); Ken Van Nimwegen, Marietta, GA (US)

(21) Appl. No.: 13/171,896

(22) Filed: Jun. 29, 2011

Related U.S. Application Data
(60) Provisional application No. 61/359,639, filed on Jun. 29, 2010.

(51) Int. Cl. B32B 3/26; B05D 3/12; C08L 79/04; C09D 127/12; C09D 5/18

(52) U.S. Cl. 428/304.4; 524/544; 427/365

(57) ABSTRACT

An aircraft insulating foam includes a base foam and a coating. The base foam is an open celled foam with a plurality of interconnected open cells. The interconnected open cells and the outside of the base foam define a surface area. The coating is deposited on the surface area. The coating includes a water repellant material and a fire resistant material. The aircraft insulating foam may be made by providing a base foam having a plurality of interconnected open cells, providing a coating including a water repellant material and a fire resistant material, and depositing the coating upon the surface area of the provided base foam.

### RELATED APPLICATION

This application claims the benefit of co-pending U.S. Provisional Patent Application Ser. No. 61/359,639 filed Jun. 29, 2010.

### FIELD OF INVENTION

The instant invention relates to hydrophobic and fire resistant insulating foam that may be used as insulation in an aircraft, and the method of making the same.

### BACKGROUND OF THE INVENTION

Recently, foam has been introduced for insulating the walls of an aircraft fuselage. Insulation for an aircraft fuselage is typically provided between the fuselage and the interior wall. Aircraft fuselage insulation provides a number of functions including regulation of temperature, reduction of engine noise, and reduction of noise from outside air turbulence. Materials used in this application must minimize fire spread and flame propagation, and generate very low quantities of smoke and toxicity when exposed to fire. It is also desirable for these materials to be lightweight and to minimize water absorption or wicking of any fluids. Also, because of the constant change in altitude and pressures, insulation for an aircraft fuselage provides protection of mechanical and structural components within the aircraft system from moisture and temperature extremes that might tend to damage or corrode the components. For these reasons, most aircraft manufacturers have very stringent standards regarding all the functions of the aircraft fuselage insulation.

Previously, fiberglass systems were used for insulating the walls of an aircraft fuselage. These fiberglass systems have been used adequately for many years. However, in recent years many problems have been discovered with such fiberglass systems. Fiberglass insulation systems for aircrafts often have problems associated with delamination (splitting apart of layers), respirability, sagging, poor water repellency in bilge water, inability to shed water at seams after entering through penetrations/cutouts, and flammability of films after gathering or accumulating oil/fuel/grime etc. As a result, aircraft manufactures have looked for other materials for the replacement of such fiberglass systems.

Currently, solid foams have been introduced to solve the problems associated with fiberglass systems. Solid foams can be classified into two categories based on their pore structure, open celled foams and closed celled foams. Open celled foams contain pores that are connected to each other and form an interconnected network. Closed celled foams do not have interconnected pores. The closed cell structure foams have higher dimensional stability, a lower moisture absorption coefficient and higher strength compared to open cell structured foams.

Closed cell foams were originally more desirable than open celled foams when insulating the walls of an aircraft fuselage because they are relatively moisture resistant. However, closed cell foams are un-flexible or brittle (causes cells to break down under compressive loads) this property requires the closed cell foams to be produced in thin layers in order to fit into the spaces between the walls of an aircraft fuselage. Thin closed cell foams do not typically provide adequate noise absorption for use in the aircraft fuselage. As such, a hefty amount of closed cell foam layers must be applied which adds to manufacturing costs in terms of raw material costs, installation costs, weight, and space constraints. Furthermore, because the closed cell structures have a low moisture absorption coefficient, the closed celled foams are difficult, if not impossible, to add a treatment to the entire foam. Closed celled foams are typically treated with a spray system, curtain coater, etc., however, these systems only treat the outside of the foam and are ineffective in treating the inner cells of the closed cell foam. Thus, the insides of these closed cell foams can not include treatments for water repellency and/or flame resistance.

It is thus highly desirable to create an open celled foam for insulating the walls of an aircraft fuselage that solves the above mentioned problems and is hydrophobic (or water repellant), and flame resistant. It is also desirable that the insulation be cost effective in terms of fabrication, installation and life cycle.

The instant invention is designed to address the above mentioned problems.

### SUMMARY OF THE INVENTION

The instant invention is an aircraft insulating foam. The aircraft insulating foam includes a base foam and a coating. The base foam is an open celled foam with a plurality of interconnected open cells. The interconnected open cells and the outside of the base foam define a surface area. The coating is deposited on the surface area. The coating includes a water repellant material and a fire resistant material. The aircraft insulating foam may be made by providing a base foam having a plurality of interconnected open cells, providing a coating including a water repellant material and a fire resistant material, and depositing the coating upon the surface area of the provided base foam.

### BRIEF DESCRIPTION OF THE DRAWINGS

For the purpose of illustrating the invention, there is shown in the drawings one embodiment of the present invention; it being understood, however, that this invention is not limited to the precise arrangements and instrumentalities shown.

FIG. 1 is a cross-sectional view of a wall of an aircraft fuselage that has been partially insulated with one embodiment of the aircraft insulating foam according to the instant invention.

### DETAILED DESCRIPTION OF THE INVENTION

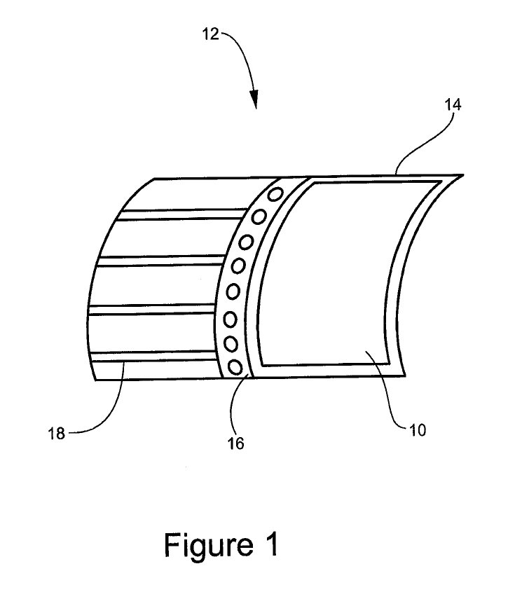

Referring to the drawings, wherein like numerals indicate like elements, there is shown in FIG. 1 a wall of an aircraft fuselage 12 that is partially insulated with aircraft insulating foam 10. Wall 12 may be any wall of an aircraft fuselage. Wall 12 may be constructed by any means, including, but not limited to a box truss structure, a geodesic construction, a monocoque shell or a semi-monocoque. Wall 12 may include an external skin 14. Aircraft insulating foam 10 may be juxtaposed to external skin 14. Wall 12 may further include a plurality of trusses 16 and a plurality of stringers 18. Although the instant invention of aircraft insulating foam 10 is directed toward use in insulating the wall of an aircraft, the invention is not so limited. As should be understood by one skilled in the art, the aircraft insulating foam 10 of the instant invention may also be utilized in other areas requiring a hydrophobic and/or flame resistant insulation or foam.

Aircraft insulating foam 10 generally may include a base foam and a coating. Aircraft insulating foam 10 may be an open celled foam that is hydrophobic (water repellant) and/or flame resistant (FR). The base foam of aircraft insulating foam 10 may be any type of open celled foam. Aircraft insulating foam 10 may be used for many applications, including, but not limited to, insulating the walls of an aircraft fuselage.

The base foam may be included in aircraft insulating foam 10. The base foam may be for providing the foundation foam of aircraft insulating foam 10. The base foam may be any type of open celled foam, including, but not limited to, a resilient fire resistant foam. A resilient fire resistant foam may be, but is not limited to, a melamine foam. Melamine foam is available from BASF of New Jersey under the trade name BASOTECT®. The base foam may have a number of desired properties, including, but not limited to, low density or low weight, low thermal conductivity, good fire protection, good flexibility, high sound insulation efficiency, etc.

The base foam may be of any structure, including but not limited to, an open celled structure. The open celled structure of the base foam may include a plurality of interconnected open cells. The interconnected open cells in combination with the outside of the base foam may define a surface area. The coating may be deposited upon the surface area, thus, providing hydrophobic and/or flame resistant treatments to the base foam. The interconnected open cells, or the open cell structure of the base foam, may provide the access to the entire surface area to apply the hydrophobic and flame resistant treatment or coatings to the base foam, or in other words.

The coating may be deposited on or in the surface area of the base foam of aircraft insulating foam. The coating may be any coating deposited on the surface area of the base foam. The coating may generally include a water repellant material and a fire resistant material. The coating may also include a liquid like water for emulsifying the materials.

The water repellant material of the coating may be deposited on or in the surface area of the base foam. The water repellant material of the coating may make the base foam water repellant, or otherwise known as hydrophobic. The water repellant material may be any hydrophobic coating or water repellant substance. In one embodiment, the water repellant material may be a mixture of water repellant substances, including, but not limited to a mixture of chemicals. For example, the chemical mixture may include, but is not limited to, fluoropolymers, waxes, hydrocarbon emulsions, and mixtures thereof. The fluoropolymers, waxes (or wax emulsions) and hydrocarbon emulsions may be those used to make water repellant textiles. In one embodiment, the water repellant material may include a fluoropolymer being Unidyne™ TG-5601. Unidyne™ TG-5601 may be provided by Daikin Industries of Carrollton, Tex. In one embodiment, the water repellant material may range from between 0.05% and 5.00% by weight of the coating. In another embodiment, the water repellant material may be between 0.10% and 0.50% by weight of the coating. Once deposited on the foam, the water repellant material may be added to the basis weight of the treated base foam. In one embodiment, the water repellant material may range from 0.01% and 10.00% by weight of the foam. In another embodiment, the water repellant material may range from 0.25% and 3.00% by weight of the foam.

The fire resistant or FR material of the coating may be deposited on or in the surface area of the base foam. The fire resistant material of the coating may make the base foam fire resistant, also known as flame or fire retardant, or just FR. The fire resistant material may be any FR coating or fire resistant substance. In one embodiment, the fire resistant material may be a mixture of fire resistant materials, including, but not limited to a mixture of fire resistant chemicals. In another embodiment, the fire resistant material may include a fire retardant being Flameproof 1528. Flameproof 1528 may be provided by Apexical, Inc. of Spartanburg, S.C. In one embodiment, the flame resistant material may range from between 0.01% and 3.00% by weight of the coating. In another embodiment, the flame resistant material may range from between 0.38% and 0.57% by weight of the coating. Once deposited on the foam, the flame resistant material may be added to the basis weight of the treated base foam. In one embodiment, the flame resistant material may range from between 0.50% and 15.00% by weight of the foam. In another embodiment, the flame resistant material may range from between 2.00% and 6.00% by weight of the foam.

A liquid may be included in the emulsified solution of the coating. The liquid may be any liquid for aiding in emulsifying the materials of the solution, including the water repellant materials and the flame resistant materials. In one embodiment, the liquid may be water. However, the invention is not limited to water and other liquids may be used to aid in emulsifying the materials of the coating. In one embodiment, the liquid may range from between 80.00% and 99.90% by weight of the coating. In another embodiment, the liquid may range from between 98.93% and 99.52% by weight of the coating. Due to the addition of water, like tap water, the pH of the emulsified solution of the coating may or may not need to be maintained depending on the water being used. For example, in one embodiment, the emulsified solution of the coating may need to be maintained in the range of 1.0-10.0. In another embodiment, the pH may need to be maintained in the range of 4.0 to 7.0. However, if the pH is already in these ranges with the provided water, maintenance of the pH may not be required. The liquid, like water, may be completely removed from the final hydrophobic and flame resistant treated foam by various manufacturing processes as discussed below, i.e., compressing, drying and/or curing, or by other means. As a result, the liquid or water is not present in aircraft insulating foam 10 and does not add any amount to the basis weight.

A method of making aircraft insulating foam 10 may be for producing a hydrophobic and flame resistant open celled foam and may include any steps for producing such a hydrophobic and flame resistant open celled foam. The method may include producing aircraft insulating foam 10 for many uses, including, but not limited to, insulating the walls of an aircraft fuselage. Generally, the method of making aircraft insulating foam 10 may include: providing the base foam; providing the coating including a water repellant material and a fire resistant material; and depositing the coating on the base foam.

The step of providing the base foam may be included in the method of producing aircraft insulating foam 10. This step may be for providing the base foam, or foundation foam for producing the hydrophobic and flame resistant open celled foam. This step may also include providing a base foam having a plurality of interconnected open cells which, in combination with the outside of the base foam, may define the surface area. This step of providing the base foam may include providing a base foam being a resilient flame resistant foam, like a melamine foam. This step of providing the base foam may be providing the base foam in any size, including, but not limited to, 2500×1250×500 mm untreated buns. This step may further include a step of shaping the base foam.

The step of shaping the base foam may be included in the step of providing the base foam. This step may be for shaping the base foam to the desired size for aircraft insulating foam 10. This step may include cutting the base foam with any type of cutting machine, including, but not limited to, a machine with dual oscillating blades or a revolving wire. Dual oscillating blades may be one embodiment of the cutting machine because this may reduce dusting and may also enhance cutting surface properties. An example of a machine used for the step of shaping the base foam may be, but is not limited to, a Wintech Contour Cutter equipped with either dual oscillating blades or a revolving wire. This step of shaping the base foam may include cutting the base foam to any thickness, including, but not limited to, a 1 inch thickness or a 3.6 inch thickness.

The step of providing the coating including a water repellant material and a fire resistant material may be included in the method of producing aircraft insulating foam 10. This step may be for providing the water repellant and flame resistant coating, or a hydrophobic and flame resistant treatment for the base foam. This step may include any steps for providing the coating. This step of providing the coating may include a step of mixing a solution of the water coating and a liquid in a mix tank, and a step of emulsifying the mixed solution.

The step of mixing a solution of the coating and a liquid in a mix tank may be included in the step of providing the coating. This step may be for mixing the coating with a liquid (e.g. water, alcohol or both). This step may include any steps for mixing the coating with a liquid. This step may include mixing the coating with a liquid in a mix tank. The mix tank may be any mix tank for mixing the coating with a liquid. The mix tank may be a mix tank equipped with agitators to achieve the appropriate concentration of both liquid and solid additives for obtaining a mixed solution. This step of mixing the coating may include pumping the mixed solution into a blend tank for consolidation.

The step of emulsifying the mixed solution may be included in the step of providing the coating. This step may be for emulsifying the mixed solution from the previous step of mixing the coating with a liquid. This step may include any steps for emulsifying the mixed solution. This step may include forcing the mixed solution through an emulsifying device. The emulsifying device may be any device for emulsifying the mixed solution, including, an in-line device that employs pressure and ultrasonic cavitational forces strong enough to emulsify the mixed solution without shearing it. Once the desired level of consistency is achieved in the emulsifying device, an emulsified solution may be formed. The emulsified solution may be piped to a holding tank for application to the base foam.

The step of depositing the coating on the surface area of the base foam may be included in the method of producing aircraft insulating foam 10. This step may be for treating the base foam with the water repellant and flame resistant coating to make the base foam become hydrophobic or repellant to water and to make the base foam flame resistant, flame retardant or FR. This step may include any steps for depositing the coating on the surface area of the base foam. In one embodiment, this step may include, but is not limited to: a step of compressing the base foam; a step of submerging the compressed base foam into the emulsified solution of the coating; a step of expanding the submerged base foam thereby absorbing the emulsified solution of the coating; a step of allowing the coating to settle on to the surface area; a step of compressing the base foam to remove the liquid mixed with the coating; a step of removing the compressed base foam from the emulsified solution of the coating; a step of allowing the base foam to expand; a step of drying the treated base foam; and a step of curing the treated base foam.

The step of compressing the base foam may be included in the step of depositing the coating on the surface area of the base foam. This step may be for compressing the base foam to allow for the base foam to expand when submerged in the emulsified solution of the coating. This step may include any step for compressing the base foam. This step may include moving the base foam through a first pair of nip rollers for completely compressing the base foam.

The step of submerging the compressed base foam into the emulsified solution of the coating may be included in the step of depositing the coating on the surface area of the base foam. This step may be for submerging the compressed base foam into the emulsified solution of the coating to allow for the introduction of the emulsified solution of the coating into the base foam. This step may include any steps for submerging the compressed base foam into the emulsified solution, including but not limited to, manual or by an automated process.

The step of expanding the submerged base foam may be included in the step of depositing the coating on the surface area of the base foam. This step may be for absorbing the emulsified solution of the coating through the walls of the surface area. This step may include any steps for expanding the submerged base foam. This step may include, but is not limited to, compression by a perforated roll with a pneumatic height adjustment to keep the base foam submerged. The perforated roll may be set up to react automatically to a signal generated by a depth gauge mounted in the tank.

The step of allowing the coating to settle on to the surface area may be included in the step of depositing the coating on the surface area of the base foam. This step may be for allowing the water repellant and flame resistant coating to settle on to the surface area. This step may include any steps for allowing the water repellant and flame resistant coating to settle on to the surface area. This step may include allowing the base foam to stay submerged for any period of time, for example, until the base foam becomes fully saturated with the emulsified solution of the water repellant and flame resistant coating.

The step of compressing the base foam to remove the liquid mixed with the coating may be included in the step of depositing the coating on the surface area of the base foam. This step may be for compressing the base foam to remove the liquid mixed with the coating from the base foam, thus treating the base foam with the water repellant and flame resistant coating. This step may include any steps for removing the liquid mixed with the coating. In this step of compressing the base foam, the plurality of interconnected cell walls may filter, or maintain, the water repellant and flame resistant coating which will ultimately make the base foam hydrophobic or water repellant, and flame resistant, fire retardant or FR. This step may include moving the base foam through a second pair of nip rollers for completely compressing the treated base foam.

The step of removing the compressed treated base foam from the emulsified solution may be included in the step of depositing the water repellant coating on the surface area of the base foam. This step may be for removing the compressed treated base foam from the emulsified solution to allow for drying and curing. This step may include any steps for removing the treated base foam from the emulsified solution, including, but not limited to, manually or by an automated process.

The step of expanding the treated base foam may be included in the step of depositing the coating on the surface area of the base foam. This step may be for expanding the treated base foam to allow for drying and curing of the treated base foam. This step may include any steps for allowing the treated base foam to expand. This step may include removing the treated base foam from the second pair of nip rollers.

The step of drying the treated base foam may be included in the step of depositing the coating on the surface area of the base foam. This step may be for drying or removing the excess liquid not removed by compression in the previous step from the treated base foam. This step may include any steps for drying the treated base foam. This step may include applying a vacuum to the treated base foam, for example, moving the treated base foam through a vacuum table.

The step of curing the treated base foam may be included in the step of depositing the coating on the surface area of the base foam. This step may be for curing the water repellant and flame resistant coating onto the surface area of the base foam. This step may include any steps for curing the treated base foam. This step may include inserting the treated base foam into an oven. The oven may be any oven, including, but not limited to an oven with vents and baffles adapted for even distribution of air flow across and through the treated base foam. Curing time may be any time necessary, including, but not limited to 5 to 35 minutes. For example, in one embodiment, the curing time may be for between 0.5 hours and 15.0 hours. In another embodiment, the curing time may be for approximately 12.0 hours.

### EXAMPLES

Various examples of aircraft insulating foam 10 were made according to the instant invention. In all the samples, the base foam was a melamine open-celled foam from BASF of New Jersey under the trade name BASOTECT®. All the base foams were treated with the coating according to the process discussed above. The coating contained: a water repellant material fluoropolymer being Unidyne® TG5601 provided by Daikin Industries of Carrollton, Tex.; a flame resistant material being Flameproof 1528 provided by Apexical, Inc. of Spartanburg, S.C.; and water. In the various examples, the Unidyne® TG5601 fluopolymer was between 0.10% and 0.50% by weight of the coating solution. Also, the Flameproof 1528 fire retardant was between 0.38% and 0.57% by weight of the coating solution. In addition, the water was between 98.93% and 99.52% by weight of the coating solution. After the base foams were treated with the coating solution, the treated foam was dried to remove the water according the process discussed above. This resulted in the example base foams having: between 0.25% and 3.00% by weight of the treated foam being the Unidyne® TG5601 fluopolymer; and between 2.00% and 6.00% by weight of the treated foam being the Flameproof 1528 fire retardant.

The resulting example foams were tested to see if the various foams met certain requirements of the aircraft industry in order to be an aircraft insulating foam. The foams were tested for their hydrophobic properties, fire retardant properties, and also the levels of smoke and toxicity given off by the foam. The hydrophobic properties were tested per ASTM D2842. The results of the hydrophobic tests were that the foams met or exceeded the aircraft industry standards of a weight gain of less than 5% tested per ASTM D2842. The fire retardant properties were tested per FAR 25.856a. The results of the fire retardant tests were that the foams met or exceeded the aircraft industry standards of passing the radiant burn test per FAR 25.856a. The standard smoke and toxicity tests were tested per customer specification and the foams met or exceeded all customer specifications.

The present invention may be embodied in other forms without departing from the spirit and the essential attributes thereof, and, accordingly, reference should be made to the appended claims, rather than to the foregoing specification, as indicated in the scope of the invention.

We claim:

1. An insulating foam comprising:
a foam having a plurality of interconnected open cells, said interconnected open cells and the outside of the foam defining a surface area; and
a coating being deposited upon said surface area;
said coating comprising:
a water repellant material; and
a fire resistant material.

2. The insulating foam of claim 1 where said foam being a resilient flame resistant foam being a low density melamine foam.

3. The insulating foam of claim 1 where said water repellant material comprising:
a fluoropolymer;
said fluoropolymer being Unidyne TG5601; and
said fluoropolymer being between 0.01% and 10.00% by weight of said insulating foam.

4. The insulating foam of claim 3 wherein said fluoropolymer being between 0.25% and 3.00% by weight of said insulating foam.

5. The insulating foam of claim 1 where said fire resistant material comprising:
a fire retardant;
said fire retardant being Flameproof 1528; and
said fire retardant being between 0.50% and 15.00% by weight of said insulating foam

6. The insulating foam of claim 5 where said fire retardant being between 2.00% and 6.00% by weight of said insulating foam.

7. The insulating foam of claim 1 being used in insulating the walls of an aircraft.

8. A coating for an insulating foam comprising:
a water repellant material; and
a fire resistant material.

9. The coating of claim 8 where said water repellant material comprising:
a fluorochemical;
said fluoropolymer being Unidyne TG-581; and
said fluoropolymer being between 0.05% and 5.00% by weight of said coating.

10. The coating of claim 9 where said fluopolymer being between 0.10% and 0.50% by weight of said coating.

11. The coating of claim 8 where said fire resistant material comprising:
a fire retardant;
said fire retardant being Flameproof 1528; and
said fire retardant being between 0.01% and 3.00% by weight of said coating

12. The coating of claim 11 wherein said fire retardant being between 0.38% and 0.57% by weight of said coating.

13. The coating of claim 8 further comprising:
water;
said water being between 80.00% and 99.90% by weight of said coating.

14. The coating of claim 13 wherein said water being between 98.93% and 99.52% by weight of said coating.

15. The coating of claim 8 wherein said coating having a pH in the range of 1.0-10.0.

16. The coating of claim 15 wherein said coating having a pH in the range of 4.0-7.0.

17. A method of making an insulating foam comprising the steps of:
shaping a foam having a plurality of interconnected open cells, said interconnected open cells defining a surface area; and
depositing a coating upon said surface area;
said coating including a water repellant material, a flame resistant material, and water

18. The method of claim 17 wherein:
said shaping step comprising cutting said foam including a step of using a machine with oscillating blades or a reciprocating wire;
said depositing step comprising:
mixing a solution of said coating in a mix tank, where said mix tank having agitators to achieve the appropriate concentration of both liquid and solid additives;
emulsifying said solution;
continuously agitating said solution;
continuously maintaining the pH of said solution;
compressing said foam including a step of moving said foam through a pair of nip rollers;
submerging said compressed foam into said emulsified solution;
expanding said submerged foam, thereby absorbing said emulsified solution;
allowing said coating to settle on to said surface area;
compressing said foam to remove the liquid;
removing said compressed foam from said solution;
allowing said foam to expand;
drying said foam including a step of applying a vacuum to said foam and/or placing the foam into a centrifugal chamber; and
curing said foam including a step of inserting said foam into an oven, wherein said oven being adapted for even distribution of air flow across and through said foam, and said oven being set to a temperature between 280° F. and 400° F.

19. The method of claim 18 where said curing step being for 0.5 hours and 15.0 hours.

20. The method of claim 19 wherein said curing step being for approximately 12.0 hours.
